(19) United States
(12) Patent Application Publication
(10) Pub. No.: US 2018/0370841 A1
(43) Pub. Date: Dec. 27, 2018

(54) METHOD FOR MANUFACTURING OPTICAL FIBER PREFORM, METHOD FOR MANUFACTURING OPTICAL FIBER, AND METHOD FOR DOPING SILICA GLASS

(71) Applicant: FUJIKURA LTD., Tokyo (JP)

(72) Inventor: Takayuki Kitamura, Chiba (JP)

(73) Assignee: FUJIKURA LTD., Tokyo (JP)

(21) Appl. No.: 16/013,541

(22) Filed: Jun. 20, 2018

(30) Foreign Application Priority Data
Jun. 21, 2017 (JP) 2017-121711

(51) Int. Cl. C03B 37/014; C03B 37/018; C03B 37/027

(52) U.S. Cl. CPC C03B 37/01433; C03B 37/01473; C03B 2203/22; C03B 37/027; C03B 2201/50; C03B 37/018

(57) ABSTRACT

Provided is an alkali doping process of bringing a melt of an alkali metal compound or an alkaline earth metal compound into contact with a part of the inner circumferential surface of a silica glass tube, and thus doping the silica glass tube with the alkali metal compound or the alkaline earth metal compound, and in the alkali doping process, the contact location between the inner circumferential surface of the silica glass tube and the melt is moved along the longitudinal direction of the silica glass tube while rotating the silica glass tube around its longitudinal axis.

### TECHNICAL FIELD

One or more embodiments of the present invention relate to a method for manufacturing an optical fiber preform, a method for manufacturing an optical fiber thereof, and a method for doping silica glass.

### BACKGROUND

In order to achieve longer optical transmission distances and higher optical transmission speeds in optical fiber communication systems, the optical signal/noise ratio has to be increased. Therefore, the transmission loss of optical fibers is required to be reduced. At present, as methods for manufacturing optical fibers are highly refined, it is believed that the transmission loss due to the impurities contained in the optical fiber is almost reduced down to the limit. The main cause of the remaining transmission loss is scattering loss associated with fluctuations in the structure and composition of the glass constituting the optical fibers. This loss is inevitable because optical fibers are composed of glass.

As an optical fiber which can reduce the scattering loss associated with fluctuations in the structure and composition of glass as mentioned above, an optical fiber is known where a core is composed of silica glass doped with a small amount of alkali metal oxide or alkaline earth metal oxide, and a clad is composed of silica glass doped with fluorine. Hereinafter, alkali metal oxides and alkaline earth metal oxides may be referred to as alkaline oxides in some cases.

The softening point of silica glass is largely lowered by doping the silica glass with an alkaline oxide. More specifically, in the case of comparison with silica glass doped with no alkaline oxide at the same temperature, silica glass doped with an alkaline oxide is low in viscosity, and structural relaxation is thus easily promoted. For this reason, in preparing an optical fiber preform so that silica glass doped with an alkaline oxide serves as a core, and drawing the optical fiber preform to manufacture an optical fiber, the structural fluctuation of the silica glass constituting the core is promptly reduced. As a result, an optical fiber which can reduce the transmission loss can be manufactured.

Patent Literature 1 below discloses a method of manufacturing an optical fiber preform by doping silica glass with an alkaline oxide. In the method described in the following Patent Literature 1, first, a silica glass tube made of pure silica glass is prepared, the silica glass tube is hung on a glass forming lathe for use in modified chemical vapor deposition (MCVD) method, and a gas containing oxygen is flowed as a carrier gas in the hollow of the silica glass tube. Next, a compound of an alkali metal or an alkaline earth metal, which is a raw material for the alkaline oxide, is disposed in a solid state upstream of the silica glass tube in the direction in which the carrier gas flows. Hereinafter, compound of alkali metals or alkaline earth metals may be referred to as alkaline compounds in some cases. Next, the alkaline compound is heated by a first heating means to a temperature equal to or higher than the melting point, and thus vaporized in accordance with the vapor pressure, and the vaporized alkaline compound is flowed with the carrier gas to the other end of the silica glass tube. Next, on heating at a temperature at which the alkaline compound is turned by thermal oxidation reaction into an alkaline oxide (for example, on the order of 1300° C. to 1800° C.), by a second heating means that relatively moves with respect to the silica glass tube from an upstream side of the carrier gas to a downstream side thereof, downstream of the location where the alkaline compound is disposed, the alkali oxide is deposited on the inner circumferential surface of the silica glass tube. The site where the alkaline oxide is deposited is further heated by the second heating means, thereby diffusing the alkali oxide into the silica glass constituting the silica glass tube. The silica glass tube doped with alkaline oxide is further heated in this way to shrink and collapse the tube, thereby making it possible to provide a silica glass rod doped with the alkaline oxide. The silica glass rod doped with the alkaline oxide as just described is adopted as a core of an optical fiber. Therefore, a layer to serve as a clad is formed around such a silica glass rod, thereby making it possible to provide an optical fiber preform. In addition, Patent Literature 2 below discloses a method in which an alkaline compound is vaporized in a silica glass tube, and then cooled and thus condensed to form fine particles, which are flowed with a carrier gas from one end of the silica glass tube to the other thereof.

In addition, Patent Literature 3 below discloses a method in which an alkaline compound is vaporized in a silica glass tube, and then cooled and thus condensed to form fine particles, and the fine particles of the alkaline compound are attached to the inner circumferential surface of the silica glass tube while flowing the particles with a carrier gas in the direction from one end of the silica glass tube to the other thereof, and thereafter, heated to dope the silica glass tube with the alkaline compound.

In this regard, as a method for doping silica glass with an alkaline compound, a method of immersing a silica glass rod in a melt of an alkaline compound is also conceivable as in the method described in Patent Literature 4 below. According to this method, the silica glass rod can be doped with the alkaline compound in a short period of time, because the high-concentration alkaline compound can be brought into contact with the silica glass rod. In addition, the concentration deviation of the alkaline compound with which the silica glass rod is doped can be reduced over the entire silica glass rod by immersing the whole silica glass rod in the melt of the alkaline compound.

### [Patent Literature 1] JP 2005-537210 A

### [Patent Literature 2] JP 5656469 B2

### [Patent Literature 3] JP 5586388 B2

### [Patent Literature 4] JP 5894828 B2

However, for the methods described in Patent Literatures 1 to 3 mentioned above, it is difficult to control the amounts of vapors of the alkaline compounds, and it is difficult to control the concentration deviation s of the alkaline compounds for doping in the longitudinal directions of the silica glass tubes. In addition, the inventor has found that the method described in Patent Literature 4 mentioned above may crystallize the silica glass rod doped with the alkaline compound in some cases.

### SUMMARY

One or more embodiments of the present invention provide a method for doping silica glass, which can reduce the concentration deviation of the alkali metal compound or the alkaline earth metal compound for doping in the longitudinal direction of the silica glass tube while suppressing the crystallization of the silica glass tube; a method for manufacturing an optical fiber preform with the use of the doping method; and a method for manufacturing an optical fiber with the use of the optical fiber preform.

A method for manufacturing an optical fiber preform according to one or more embodiments of the present invention includes: a glass tube preparing process of preparing a silica glass tube; an alkali doping process of bringing a melt of an alkali metal compound or an alkaline earth metal compound into contact with a part of the inner circumferential surface of the silica glass tube, and thus doping the silica glass tube with the alkali metal compound or the alkaline earth metal compound; a collapsing process of, after the alkali doping process, heating the silica glass tube to reduce the tube in diameter and collapse the tube, and thus preparing a silica glass rod; and an externally attached layer forming process of forming a silica glass layer on the outer circumferential surface of the silica glass rod, and in the alkali doping process, the contact location between the inner circumferential surface of the silica glass tube and the melt is moved along the longitudinal direction of the silica glass tube while rotating the silica glass tube around its axis.

In one or more embodiments, the contact location between the inner circumferential surface of the silica glass tube and the melt of the alkaline compound is moved in the longitudinal direction of the silica glass tube. The inner circumferential surface of the silica glass tube and the melt of the alkaline compound come into contact with each other, thereby doping the silica glass tube with the alkaline compound. Therefore, the concentration deviation of the alkali metal compound or alkaline earth metal compound with which the silica glass tube is doped can be reduced by adjusting the movement speed or the like of the contact position between the inner circumferential surface of the silica glass tube and the melt of the alkaline compound in the longitudinal direction of the silica glass tube. In addition, in the above-mentioned method for manufacturing the optical fiber preform, the alkali doping process is performed while rotating the silica glass tube around its axis. Therefore, the contact location between the inner circumferential surface of the silica glass tube and the melt is moved in the circumferential direction of the silica glass tube, and the concentration deviation of the alkali metal compound or alkaline earth metal compound with which the silica glass tube is doped can be thus reduced.

In one or more embodiments, the inventor has found that crystallization of silica glass as in the case of the silica glass rod in the method described in Patent Literature 4 mentioned above can be suppressed by bringing the melt of the alkaline compound into contact with only a part of the inner circumferential surface of the silica glass tube. The reason therefore is not known, but considered as follows. When the silica glass is doped with an alkaline compound, an addition reaction is developed with respect to the Si—O—Si bonds of the silica glass, and alkali metal ions or alkaline earth metal ions penetrate into gaps of the SiO₄ network while cleaving the Si—O—Si bonds. For this reason, when the silica glass is doped with an alkaline compound, the silica glass shrinks in volume, and increases in density. However, in of one or more embodiments, when the concentration of the alkaline compound with which the silica glass is doped is higher than a certain amount, it is believed that the alkali metal ions or the alkaline earth metal ions fail to penetrate completely into the gaps of the SiO₄ network, thereby turning the volume of the silica glass into expansion. It is believed that depending on the morphology of the silica glass, a difference is produced between the generation and relaxation of the stress caused by the density change and the morphological change as mentioned above, thereby producing a difference in the progress of the crystallization of the silica glass. Specifically, as compared with a case of doping with an alkaline compound by bringing the melt of the alkaline compound into contact with the outer circumferential surface of rod-shaped silica glass, the crystallization of the silica glass can be suppressed in the case of doping with an alkaline compound by bringing the melt of the alkaline compound into contact with the inner circumferential surface of tubular silica glass. In addition, it is believed that as compared with a case of immersing the whole silica glass in the melt of the alkaline compound, the only partial contact location between the melt of the alkaline compound and the silica glass makes the stress likely to be relaxed, thereby making it possible to further suppress the crystallization of the silica glass. In the above-mentioned method for manufacturing the optical fiber preform of one or more embodiments, the contact location between the silica glass tube and the melt of the alkaline compound is only a part of the inner circumferential surface of the silica glass tube, and a wide area of the silica glass tube is doped with the alkaline compound by changing the contact location with time. Therefore, the crystallization of the silica glass tube can be suppressed.

In one or more embodiments, as mentioned above, the silica glass rod doped with the alkaline compound is reduced in diameter and collapsed to prepare the silica glass rod, thereby making it possible to turn the silica glass rod into the preform core part to serve as the core of the optical fiber in the optical fiber preform. The silica glass layer is formed on the outer circumferential surface of the silica glass rod, thereby making it possible to turn the silica glass layer into the preform clad part to serve as the clad of the optical fiber in the optical fiber preform. In this way, the optical fiber preform in which the concentration deviation of the alkali metal compound or alkaline earth metal compound for doping can be reduced in the longitudinal direction of the silica glass while suppressing the crystallization of the silica glass in the preform core part can be manufactured.

In addition, in the previously mentioned alkali doping process of one or more embodiments, a heat source that heats the alkali metal compound or the alkaline earth metal compound is preferably moved in the longitudinal direction of the silica glass tube.

In one or more embodiments, the melt of the alkaline compound also moves, with the movement of the heat source for heating the alkaline compound. Moving the heat source in the longitudinal direction of the silica glass tube as mentioned above makes it easy to move the contact location between the inner circumferential surface of the silica glass tube and the melt of the alkaline compound in the longitudinal direction of the silica glass tube.

In addition, in one or more embodiments, prior to the previously mentioned alkali doping process, a powder of the alkali metal compound or the alkaline earth metal compound is preferably deposited on the inner circumferential surface of the silica glass tube.

In one or more embodiments, prior to the alkali doping process, that is, before the alkali doping process, or simultaneously with the alkali doping process, the powder of the alkaline compound is deposited on the inner circumferential surface of the silica glass tube, thereby making it possible to melt the powder, and thus bring the melt of the alkaline compound and the inner circumferential surface of the silica glass tube into contact with each other. Therefore, a desired location of the inner circumferential surface of the silica glass tube can be doped with alkaline compound by adjusting the location where the powder of the alkaline compound is deposited.

In addition, it is preferable to include in one or more embodiments, after the alkali doping process, an additional heating process of further heating the silica glass tube without supplying the alkali metal compound or the alkaline earth metal compound.

In one or more embodiments, the alkali compound remaining on the inner circumferential surface of the silica glass tube after the alkali doping process can be removed by further heating the silica glass tube as just described. In addition, in such a case where the alkaline compound with which the silica glass tube is doped is unevenly distributed on the inner circumferential surface of the silica glass tube, the concentration of the alkaline compound in the silica glass tube can be equalized by further heating the silica glass tube as mentioned above. In addition, internal stress generated in the silica glass tube by doping the silica glass tube with the alkaline compound can be relaxed by performing the foregoing additional heating process.

In one or more embodiments, a gas is preferably flowed on the inner circumferential surface of the silica glass tube from one end of the silica glass tube toward the other thereof in the alkali doping process.

Flowing the gas on the inner circumferential surface of the silica glass tube as just described can limit the direction of moving the melt of the alkaline compound and the powder to the direction of flowing the gas, and the alkaline compound can be thus effectively utilized in some embodiments.

In addition, the gas of one or more embodiments preferably contains oxygen.

In one or more embodiments, flowing oxygen on the inner circumferential surface of the silica glass tube in the alkali doping process can cause the alkaline compound with which the silica glass tube is doped to develop a thermal oxidation reaction. In addition, flowing oxygen as just described can suppress the generation of oxygen-deficient defects as described below on the inner circumferential surface of the silica glass tube. For example, in the case of using potassium chloride as an alkaline compound, in the diffusion of the potassium chloride into the silica glass tube, Si—O—Si bonds are cleaved to form Si—O—K bonds and Si—Cl bonds by addition reaction. When moisture in the gas flowed on the inner circumferential surface of the silica glass tube and a slight amount of hydroxyl group (Si—O—H) contained in the silica glass tube undergo reactions, Cl is discharged as hydrochloric acid HCl to the outside of the system. Therefore, defects due to oxygen deficiency may be generated on the inner circumferential surface of the silica glass tube. In some embodiments, when the silica is heated to a very high temperature, the silica partially volatilizes, and even if the silica is desorbed as SiOx (x>2), oxygen-deficient defects may be generated.

In one or more embodiments, the gas preferably contains chlorine.

In one or more embodiments, the alkaline compound disposed on the inner circumferential surface of the silica glass tube and the impurities contained therein are partially turned into chloride by flowing chlorine on the inner circumferential surface of the silica glass tube in the alkali doping process. Most of chlorides of representative metals and transition metals, which are assumed as impurities, are heated at a temperature around the melting point of the alkali metal chloride, thereby also preferentially volatilizing rather than the alkali metal chloride. Therefore, in the alkali doping process of one or more embodiments, the purification of the alkaline compound can be promoted by flowing chlorine on the inner circumferential surface of the silica glass tube and heating the alkaline compound. It is to be noted that when chlorine is present in the gas phase, the chlorine is unlikely to affect the crystallization of the silica glass as mentioned above.

In addition, the alkali metal compound of one or more embodiments preferably includes a halide of an alkali metal.

The halide of the alkali metal, in one or more embodiments, is preferred in the case of use as a melt mentioned above, because the halide exhibits a melting point without decomposition.

In addition, the alkali metal of one or more embodiments is preferably potassium.

In one or more embodiments, when a halide of potassium is used, it is easy to set the diffusion rate into the silica glass at an appropriate rate mainly due to the atomic weight of potassium.

A method for doping silica glass according to one or more embodiments of the present invention includes: a glass tube preparing process of preparing a silica glass tube; and an alkali doping process of bringing a melt of an alkali metal compound or an alkaline earth metal compound into contact with a part of the inner circumferential surface of the silica glass tube, and thus doping the silica glass tube with the alkali metal compound or the alkaline earth metal compound, and in the alkali doping process, the contact location between the inner circumferential surface of the silica glass tube and the melt is moved along the longitudinal direction of the silica glass tube while rotating the silica glass tube around its axis.

As mentioned above, in one or more embodiments, through the alkali doping process, the concentration deviation of the alkali metal compound or the alkaline earth metal compound for doping can be reduced in the longitudinal direction of the silica glass tube while suppressing the crystallization of the silica glass tube.

In addition, a method for manufacturing the optical fiber according to one or more embodiments of the present invention is characterized in that the method includes a process of preparing the optical fiber preform by the method for manufacturing the optical fiber preform, and the drawing process of drawing the optical fiber preform.

As mentioned above, in one or more embodiments, the optical fiber preform including the silica glass rod doped with the alkaline compound and the silica glass layer formed on the outer circumferential surface of the silica glass rod is obtained according to the method for manufacturing the optical fiber preform. The optical fiber which can reduce the transmission loss is obtained by drawing the optical fiber preform.

As just described, according to one or more embodiments of the present invention, provided are: a method for doping silica glass, which can reduce the concentration deviation of the alkali metal compound or the alkaline earth metal compound for doping in the longitudinal direction of the silica glass tube while suppressing the crystallization of the silica glass tube; a method for manufacturing an optical fiber preform with the use of the doping method; and a method for manufacturing an optical fiber with the use of the optical fiber preform.

### BRIEF DESCRIPTION OF THE DRAWINGS

FIG. 1 is a cross-sectional view illustrating an optical fiber according to one or more embodiments of the present invention;

FIG. 2 is a flowchart showing processes of a method for manufacturing an optical fiber according to one or more embodiments of the present invention;

FIG. 3 is a perspective view illustrating a silica glass tube prepared in a glass tube preparing process in FIG. 2;

FIG. 4 is a diagram illustrating the state of a scene of an alkali doping process in FIG. 2;

FIG. 5 is a diagram illustrating the state of another scene of the alkali doping process in FIG. 2;

FIG. 6 is a diagram illustrating a state of a collapsing process in FIG. 2;

FIG. 7 is a perspective view illustrating a silica glass rod obtained through a collapsing process;

FIG. 8 is a diagram illustrating a state of an externally attached layer forming process by a soot method;

FIG. 9 is a perspective view illustrating a state where a required amount of silica glass soot containing fluorine is deposited on the outer circumferential surface of the silica glass rod;

FIG. 10 is a cross-sectional view illustrating an optical fiber preform;

FIG. 11 is a diagram illustrating a state of a drawing process in FIG. 2;

FIG. 12 is a diagram illustrating the state of a scene of an alkali doping process according to one or more embodiments of the present invention; and

FIG. 13 is a diagram illustrating the state of a scene of an alkali doping process according to one or more embodiments of the present invention.

### DETAILED DESCRIPTION OF THE EMBODIMENTS

Preferred embodiments of a method for doping silica glass, a method for manufacturing an optical fiber preform through the use of the doping method, and a method for manufacturing an optical fiber with the use of the optical fiber preform according to one or more embodiments of the present invention will be described below with reference to the drawings.

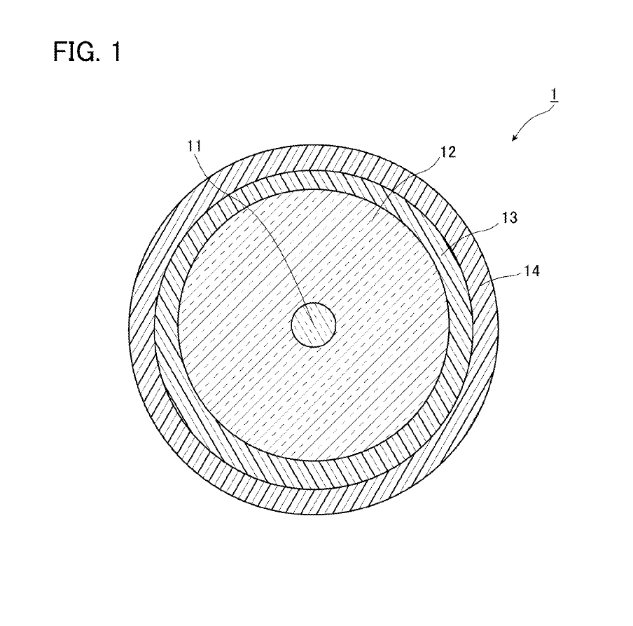

FIG. 1 is a cross-sectional view illustrating an optical fiber according to one or more embodiments of the present invention. As shown in FIG. 1, the optical fiber 1 according to the present embodiment includes a core 11, a clad 12 that surrounds the outer circumferential surface of the core 11 without gaps, an inner protective layer 13 that coats the outer circumferential surface of the clad 12, and an outer protective layer 14 that coats the outer peripheral surface of the inner protective layer 13. The core 11 is composed of silica glass doped with at least an alkali metal oxide or an alkaline earth metal oxide. In addition, the clad 12 according to the present embodiment is composed of, for example, silica glass doped with fluorine.

Next, a method for manufacturing the optical fiber 1 will be described.

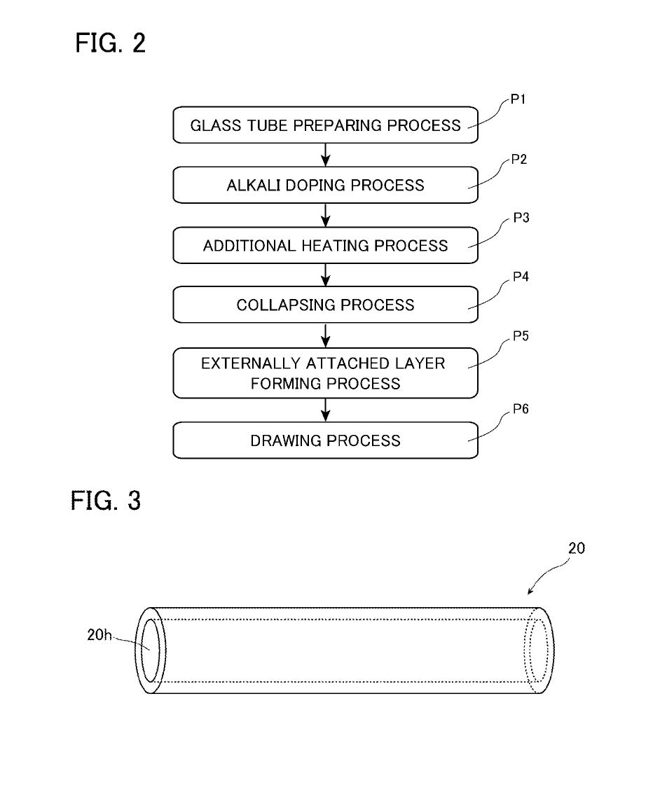

FIG. 2 is a flowchart showing processes of a method for manufacturing an optical fiber according to one or more embodiments of the present invention. The method for manufacturing an optical fiber as shown in FIG. 2 includes a glass tube preparing process P1, an alkali doping process P2, an additional heating process P3, a collapsing process P4, an externally attached layer forming process P5, and a drawing process P6.

<Glass Tube Preparing Process P1>

In one or more embodiments, the glass tube preparing process P1 is a process of preparing a silica glass tube 20 with a hollow 20h in the center. FIG. 3 is a perspective view illustrating the silica glass tube 20 prepared in the glass tube preparing process P1.

As the silica glass tube 20, for example, a commercially available synthetic silica glass tube for optical fiber can be used. The silica glass tube 20 may be made of pure silica glass without any dopant added thereto, or with a dopant other than alkaline compounds added thereto. Examples of such a dopant include, for example, chlorine, fluorine, and germanium. These dopants may be adopted for doping with more than one type of dopant, or for doping so as to generate a concentration distribution in the thickness direction. However, the silica glass tube serves as the core 11 as described later, and the concentration of the dopant added to the silica glass tube 20 is thus preferably low from the perspective of reducing the transmission loss of the optical fiber 1. The size of the silica glass tube 20 is not particularly limited, but can be, for example, 32 mm in outer diameter and 2.5 mm in wall thickness.

In addition, in the glass tube preparing process P1 according to one or more embodiments, the silica glass tube 20 is prepared which has an annular recess formed to be recessed outward at one end as will be described later.

<Alkali Doping Process P2>

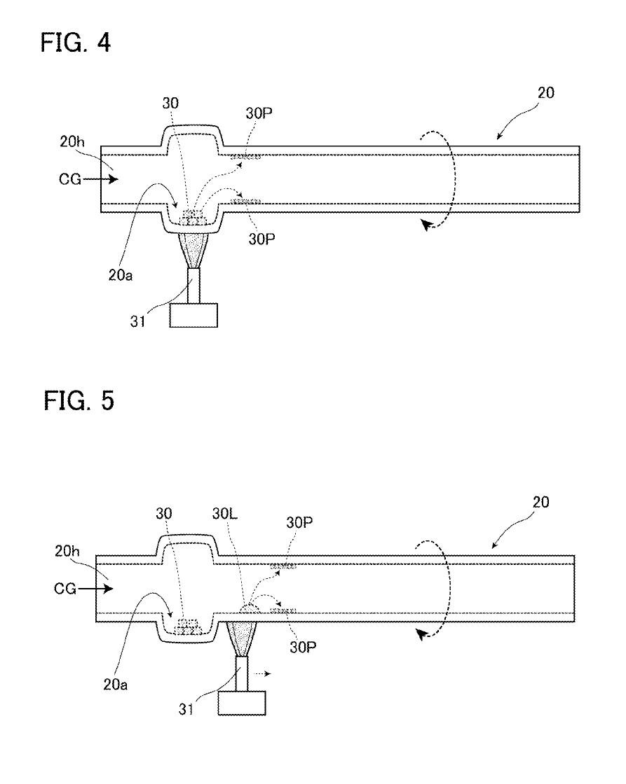

In one or more embodiments, the alkali doping process P2 is a step of bringing a melt of an alkali metal compound or an alkaline earth metal compound into contact with a part of the inner circumferential surface of the silica glass tube 20 prepared in the glass tube preparing process P1. An alkali metal compound or an alkaline earth metal compound is brought into contact with the inner circumferential surface of the silica glass tube 20, thereby doping the silica glass tube 20 with the alkali metal compound or the alkaline earth metal compound from the inner circumferential side of the silica glass tube 20. The alkali doping process P2 is performed by attaching the silica glass tube 20 to a glass forming lathe used for modified chemical vapor deposition (MCVD). FIG. 4 is a diagram illustrating the state of a scene of the alkali doping process P2. FIG. 5 is a view illustrating the state of another scene of the alkali doping process P2.

As shown in FIG. 4, in one or more embodiments, the silica glass tube 20 has an annular recess 20a recessed outward at one end. In the alkali doping process P2 according to one or more embodiments, an alkali metal or alkaline earth metal compound 30 is disposed in the recess 20a in the hollow 20h of the silica glass tube 20. According to one or more embodiments, potassium chloride (KCl) is used as the compound 30. When potassium chloride is used as the compound 30, it is easy to set the diffusion rate into the silica glass at an appropriate rate mainly due to the atomic weight of potassium.

In one or more embodiments, while rotating the silica glass tube 20 around its axis, a carrier gas CG is flowed through the hollow 20h from one end of the silica glass tube 20 toward the other thereof. For example, a gas containing dry oxygen heated to room temperature or a temperature on the order of 80° C. to 120° C. can be used as the carrier gas CG. In addition, the compound 30 is dried with an oxyhydrogen burner 31 as a heating means. For example, the compound 30 is heated at 150° C. for 15 minutes or longer. After thus drying the compound 30, the compound 30 is melted by heating further with the oxyhydrogen burner 31 while flowing the carrier gas CG through the hollow 20h as mentioned above. The heating temperature in this case can be, for example, 780° C. When the compound 30 is melted as just described, vapor of the compound 30 is generated in accordance with the vapor pressure. The generated vapor of the compound 30 is, by the carrier gas CG, swept downstream of the recess 20a in the direction of flowing the carrier gas CG. In addition, the thus swept vapor of the compound is cooled and condensed into a powder 30P, which is deposited on the inner circumferential surface of the silica glass tube 20. In this way, the powder 30P is deposited on the inner circumferential surface of the silica glass tube 20 downstream of the recess 20a in the direction of flowing the carrier gas CG. In this case, a site of the silica glass tube 20 where the powder 30P is desired to be deposited may be cooled, thereby facilitating deposition of the powder 30P.

In one or more embodiments, as shown in FIG. 5, the oxyhydrogen burner 31 is moved relatively with respect to the silica glass tube 20 from the upstream side to the downstream side in the direction of flowing the carrier gas CG. More specifically, the oxyhydrogen burner 31 is moved in the longitudinal direction of the silica glass tube 20. At least a part of the powder 30P is heated by the oxyhydrogen burner 31 moved as just described, and thus melted into a melt 30L. The heating temperature achieved by the oxyhydrogen burner 31 in this case has only to be a temperature at which the powder 30P is melted, and can be, for example, 800° C.

As mentioned above, in one or more embodiments, the powder 30P deposited on the inner circumferential surface of the silica glass tube 20 is melted, thereby bringing the melt 30L into contact with a part of the inner circumferential surface of the silica glass tube 20, and thus doping the silica glass tube 20 with the alkaline compound from the inner circumferential surface of the silica glass tube 20. In addition, in the process of heating the melt 30L by the oxyhydrogen burner 31, a part of the melt 30L is vaporized. The vapor of the compound 30, thus generated in this manner, is cooled again, and thus condensed into the powder 30P, which is deposited on the inner circumferential surface of the silica glass tube 20. In this regard, due to the flow of the carrier gas CG, the powder 30P is deposited again on the inner circumferential surface of the silica glass tube 20 downstream of the contact location between the inner circumferential surface of the silica glass tube 20 and the melt 30L in the direction of flowing the carrier gas CG. In addition, the oxyhydrogen burner 31 is moved in the longitudinal direction of the silica glass tube 20 as mentioned above, and the powder 30P deposited again on the inner circumferential surface of the silica glass tube 20 is thus melted again by the oxyhydrogen burner 31.

In one or more embodiments, when the oxyhydrogen burner 31 is moved in the longitudinal direction of the silica glass tube 20, the melt 30L is also moved in the longitudinal direction of the silica glass tube 20 in accordance with the movement of the oxyhydrogen burner 31. In addition, the powder 30P repeats melting and condensation while moving in accordance with the movement of the oxyhydrogen burner 31 as mentioned above. Therefore, the contact location between the inner circumferential surface of the silica glass tube 20 and the melt 30L moves in the longitudinal direction of the silica glass tube 20. Furthermore, the silica glass tube 20 rotates around its axis, and the contact location between the inner circumferential surface of the silica glass tube 20 and the melt 30L moves in a spiral manner. In this manner, the inner circumferential surface of the silica glass tube 20 and the melt 30L come into contact with each other only partially and for a short period of time, and the contact location between the inner circumferential surface of the silica glass tube 20 and the melt 30L moves continuously. The difference in contact time between the inner circumferential surface of the silica glass tube 20 and the melt 30L can be reduced in the circumferential direction and the longitudinal direction by appropriately adjusting the movement speed of the oxyhydrogen burner 31 and the rotation speed of the silica glass tube 20.

<Additional Heating Process P3>

The additional heating process P3 is a process of further heating the silica glass tube 20, in one or more embodiments, without supplying the compound 30 after the alkali doping process P2. The powder 30P remaining on the inner circumferential surface of the silica glass tube 20 after the alkali doping process P2 can be removed by further heating the silica glass tube 20 as just described. In addition, in such a case where the alkaline compound with which the silica glass tube 20 is doped is unevenly distributed on the inner circumferential surface of the silica glass tube 20, the concentration of the alkaline compound in the silica glass tube 20 can be equalized by performing the additional heating process P3. In a case where the alkaline compound is excessively present in the silica glass tube 20, the silica glass constituting the silica glass tube 20 can be crystallized by a small change in thermal history. This is believed to be because the structure is made more likely to be changed by the decreased viscosity of the silica glass. Such crystallization tends to be remarkable in the case of coexistence of potassium and chlorine. This is believed to be because crystal nuclei for the silica glass are formed at sites where potassium chloride is unevenly distributed. Such crystallization of the silica glass can be suppressed by equalizing the concentration of the alkaline compound and thus suppressing uneven distribution as mentioned above. In addition, internal stress generated in the silica glass tube 20 by doping the silica glass tube 20 with the alkaline compound can be relaxed by performing the foregoing additional heating process P3.

In one or more embodiments, the alkali doping process P2 and additional heating process P3 mentioned above can be repeated until the concentration of the alkaline compound with which the silica glass tube 20 is doped reaches a desired value.

<Collapsing Process P4>

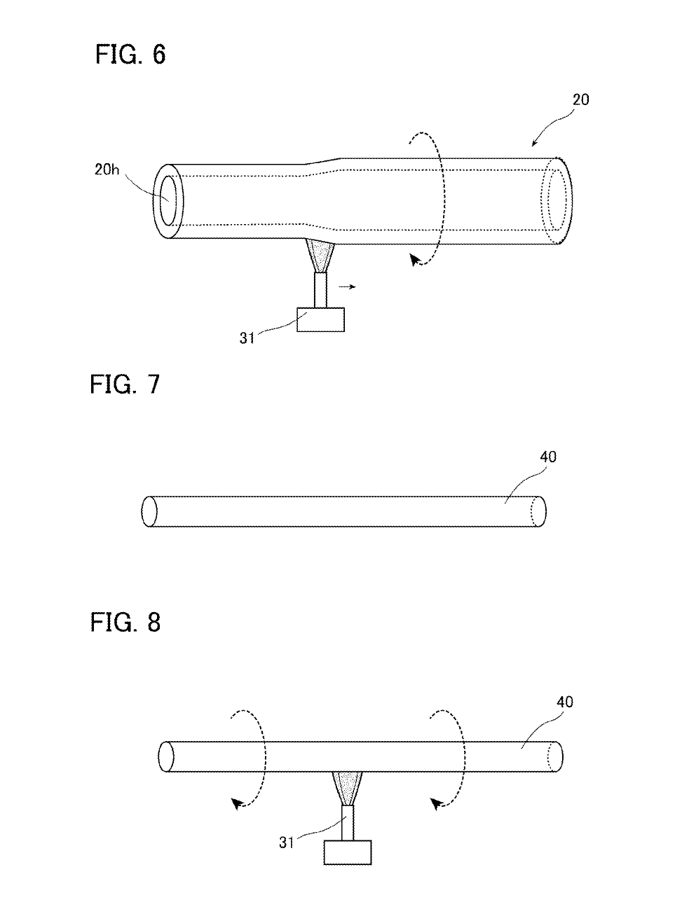

In one or more embodiments, the collapsing process P4 is a process of further heating the silica glass tube 20 doped with the alkaline compound through the alkali doping process P2 to reduce the diameter of the tube and collapse the tube, thereby providing a silica glass rod. FIG. 6 is a diagram illustrating a state of the collapsing process P4. In addition, FIG. 7 is a perspective view illustrating a silica glass rod 40 obtained through the collapsing process P4.

As shown in FIG. 6, heating the silica glass tube 20 to on the order of 2000° C. from the outer circumferential surface, for example, with the oxyhydrogen burner 31 while rotating the silica glass tube 20 around its axis can reduce the silica glass tube 20 in diameter, and collapse the silica glass tube 20. The silica glass tube 20 is heated while relatively moving the oxyhydrogen burner 31 in the longitudinal direction of the silica glass tube 20, thereby gradually reducing the entire silica glass tube 20 in diameter, and thus collapsing the silica glass tube 20. In this way, the silica glass rod 40 is obtained which is composed of the silica glass doped with the alkaline compound.

It is to be noted that in the collapsing process P4 of one or more embodiments, it is preferable to etch the inner circumferential surface of the silica glass tube 20 before collapsing the silica glass tube 20. The compound mentioned above may contain impurities such as transition metals in some cases, but the alkali oxide diffuses deep inside the silica glass tube 20, whereas the impurities are less likely to diffuse in the silica glass tube 20 than the alkali oxide, and thus tend to remain on the inner circumferential surface of the silica glass tube 20. Therefore, the impurities can be removed by etching the inner circumferential surface of the silica glass tube 20.

<Externally Attached Layer Forming Process P5>

In one or more embodiments, the externally attached layer forming process P5 is a process of forming a silica glass layer on the outer circumferential surface of the silica glass rod 40 obtained through the collapsing process P4. According to the present embodiment, a silica glass layer containing fluorine is formed on the outer circumferential surface of the silica glass rod 40. In the externally attached layer forming process P5, a silica glass layer containing fluorine can be formed, for example, by a soot method on the outer circumferential surface of the silica glass rod 40. More specifically, a fluorine-containing silica glass layer can be formed on the outer circumferential surface of the silica glass rod 40 by depositing silica glass soot on the outer circumferential surface of the silica glass rod 40, and then making the soot sintered under an atmosphere containing a fluorine-containing compound.

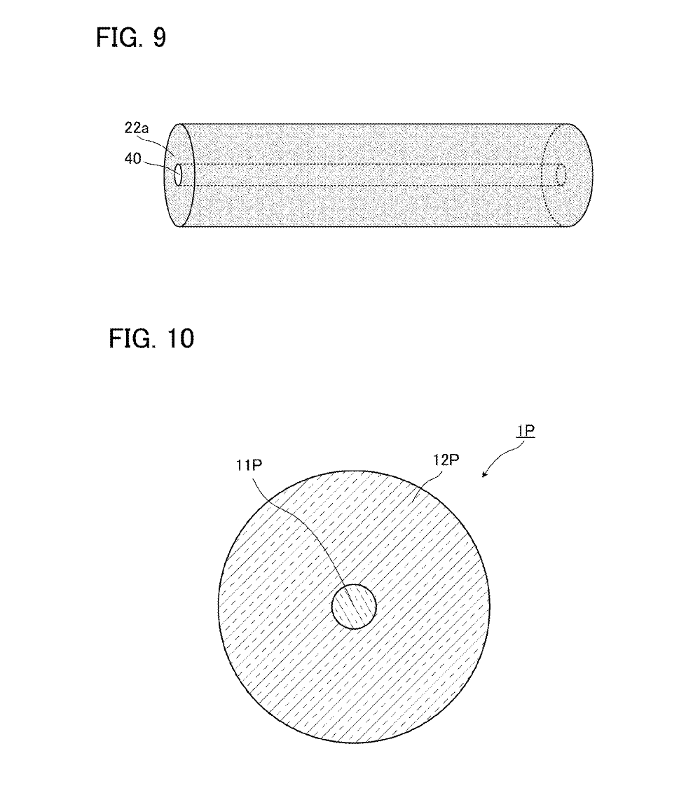

FIG. 8 is a diagram illustrating a state of the externally attached layer forming process P5 achieved by the soot method. The externally attached layer forming process P5 is carried out, for example, by an outside vapor deposition (OVD) method, and silica glass soot to serve as a fluorine-containing silica glass layer is deposited on the outer circumferential surface of the silica glass rod 40. First, the silica glass rod 40 is fixed to a chuck of a lathe (not shown), and rotated around its axis. Then, as shown in FIG. 8, while rotating the silica glass rod 40, silica glass soot to serve as a fluorine-containing silica glass layer is deposited. It is to be noted that FIG. 8 shows a state in which silica glass soot to serve as a fluorine-containing silica glass layer has not been yet deposited on the silica glass rod 40. As for the silica glass soot to be deposited, vaporized SiCl₄ is introduced with a carrier gas whose flow rate is controlled, into the flame of the oxyhydrogen burner 31, and thus turned from the SiCl₄ into SiO₂ (silica glass), and silica glass soot of the SiO₂ is deposited to coat the outer circumferential surface of the silica glass tube, while relatively moving the oxyhydrogen burner 31 several times in the longitudinal direction of the silica glass tube. In this way, the oxyhydrogen burner 31 is moved as many times as necessary, thereby resulting in a required amount of silica glass soot 22a deposited on the outer circumferential surface of the silica glass rod 40 as shown in FIG. 9.

In one or more embodiments, after the silica glass soot 22a is deposited as mentioned above, dehydration is carried out as necessary. The dehydration is carried out by aging for a predetermined period of time in a furnace provided with a heater and filled with a gas such as argon (Ar) or helium (He). Furthermore, a chlorine-containing compound such as chlorine (Cl₂) or thionyl chloride (SOCl₂) may be allowed to coexist as a dehydrating agent.

Next, fluorine-containing compounds such as silicon tetrafluoride (SiF₄), tetrafluoromethane (CF₄), and hexafluoroethane (C₂F₆) with the concentration controlled are introduced into the furnace, and the temperature inside the furnace is further raised to achieve sintering until the silica glass soot 22a turns into a transparent glass body, thereby forming a fluorine-containing silica glass layer. The furnace for use in this case may be the furnace used for the dehydration mentioned above, or a furnace that is different from the furnace used for the dehydration. However, the continuous formation from the dehydration process can suppress re-adsorption of moisture to the silica glass soot 22a, thereby providing a fluorine-containing silica glass layer which has a low water content. The fluorine-containing silica glass layer may be adapted to have a desired thickness, by performing the externally attached layer forming process P5 more than once. In this way, as shown in FIG. 10, an optical fiber preform 1P is provided which has a preform core part 11P derived from the silica glass rod 40 and a preform clad part 12P derived from the fluorine-containing silica glass layer.

<Drawing Process P6>

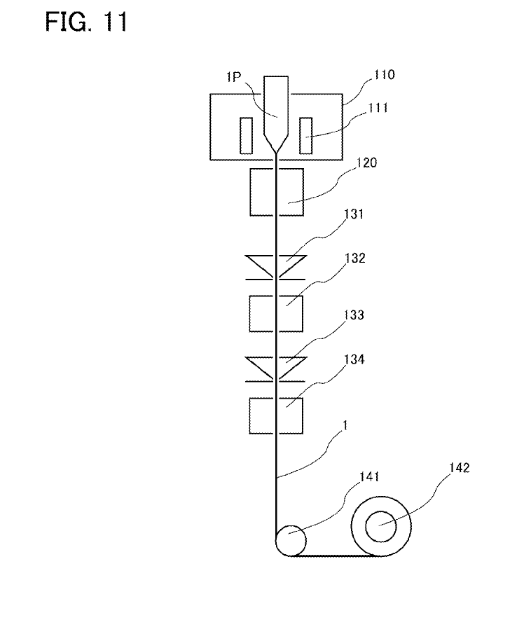

In one or more embodiments, the drawing process P6 is a process of drawing the optical fiber preform 1P prepared by the method for manufacturing an optical fiber preform, which includes the glass tube preparing process P1 to the externally attached layer forming process P5. FIG. 11 is a diagram illustrating a state of the drawing process P6. First, as a preparatory stage for performing this process, the optical fiber preform 1P is installed in a drawing furnace 110.

In one or more embodiments, a heating unit 111 of the drawing furnace 110 is allowed to generate heat, and then heats the optical fiber preform 1P. In this case, the lower end of the optical fiber preform 1P is heated to, for example, 2000° C., thereby turning into a molten state. Then, glass is molten from the optical fiber preform 1P, and the glass is drawn. Then, upon coming out of the drawing furnace 110, the drawn molten glass solidifies immediately, and the preform core part 11P turns into the core 11, whereas the preform clad part 12P turns into the clad 12, thereby providing an optical fiber strand composed of the core 11 and the clad 12. Thereafter, the optical fiber strand is cooled to an appropriate temperature by passing through a cooling device 120. In entering the cooling device 120, the temperature of the optical fiber strand is, for example, approximately 1800° C., but in exiting the cooling device 120, the temperature of the optical fiber strand is, for example, 40° C. to 50° C.

The optical fiber strand exiting the cooling device 120 passes through a coating device 131 containing therein an ultraviolet curable resin to serve as the inner protective layer 13, and the strand is thus coated with the ultraviolet curable resin. Furthermore, the ultraviolet curable resin is irradiated with ultraviolet rays by passing through an ultraviolet ray irradiation device 132, and thus cured to form the inner protective layer 13. Next, the optical fiber coated with the inner protective layer 13 passes through a coating device 133 containing therein an ultraviolet curable resin to serve as the outer protective layer 14, and the fiber is thus coated with the ultraviolet curable resin. Furthermore, the ultraviolet curable resin is irradiated with ultraviolet rays by passing through an ultraviolet ray irradiation device 134, and thus cured to form the outer protective layer 14, thereby providing the optical fiber 1 shown in FIG. 1. Alternatively, the two ultraviolet curable resins may be subjected to curing at once by coating with an ultraviolet curable resin to serve as the inner protective layer 13, then subsequently coating with an ultraviolet curing resin to serve as the outer protective layer 14 without passing through the ultraviolet ray irradiating device, and then passing the resins through the ultraviolet irradiating device for irradiating the resins with ultraviolet rays, or the two ultraviolet curable resins may be subjected to curing at once by coating with an ultraviolet curable resin to serve as the inner protective layer 13 and an ultraviolet curable resin to serve as the outer protective layer 14 at the same time in a single coating apparatus, and then passing the resins through the ultraviolet irradiating device for irradiating the resins with ultraviolet rays.

In one or more embodiments, the direction of the optical fiber 1 is changed by a turn pulley 141, and wound up by a reel 142.

In one or more embodiments, the optical fiber 1 shown in FIG. 1 is manufactured in this way.

As described above, in the method for manufacturing the optical fiber preform 1P according to one or more embodiments, the contact location between the inner circumferential surface of the silica glass tube 20 and the melt 30L of the alkaline compound is moved in the longitudinal direction of the silica glass tube 20. In addition, the inner circumferential surface of the silica glass tube 20 and the melt 30L of the alkaline compound come into contact with each other, thereby doping the silica glass tube 20 with the alkaline compound. Therefore, the concentration deviation of the alkaline compound with which the silica glass tube 20 is doped can be reduced by adjusting the movement speed of the contact location between the inner circumferential surface of the silica glass tube 20 and the melt 30L of the alkaline compound in the longitudinal direction of the silica glass tube 20. In addition, in the method for manufacturing the optical fiber preform 1P according to the present embodiment, the alkali doping process P2 is performed while rotating the silica glass tube 20 around its axis. Therefore, the contact location between the inner circumferential surface of the silica glass tube 20 and the melt 30L is moved in the circumferential direction of the silica glass tube 20, and the concentration deviation of the alkaline compound with which the silica glass tube 20 is doped can be thus reduced.

In one or more embodiments, the inventor has found that although the reason is not known as described above, crystallization of the silica glass tube 20 can be suppressed by bringing the melt 30L of the alkaline compound into contact with only a part of the inner circumferential surface of the silica glass tube 20. In the method for manufacturing the optical fiber preform 1P according to the present embodiment, the contact location between the silica glass tube 20 and the melt 30L of the alkaline compound is only a part of the inner circumferential surface of the silica glass tube 20, and a wide area of the silica glass tube 20 is doped with the alkaline compound by changing the contact location with time. Therefore, crystallization of the silica glass tube 20 can be suppressed.

In one or more embodiments, as mentioned above, the silica glass tube 20 doped with the alkaline compound is reduced in diameter and collapsed to prepare the silica glass rod 40, thereby making it possible to turn the silica glass rod 40 into the preform core part 11P to serve as the core 11 of the optical fiber 1 in the optical fiber preform 1P. The silica glass layer is formed on the outer circumferential surface of the silica glass rod 40, thereby making it possible to turn the silica glass layer into the preform clad part 12P to serve as the clad 12 of the optical fiber 1 in the optical fiber preform 1P. In this way, the optical fiber preform 1P in which the concentration deviation of the alkali metal compound or alkaline earth metal compound for doping is reduced in the longitudinal direction of the silica glass while suppressing the crystallization of the silica glass in the preform core part 11P can be manufactured.

In one or more embodiments, in the method for manufacturing the optical fiber preform 1P according to the present embodiment, the oxyhydrogen burner 31, which is a heat source for heating the alkali metal compound or the alkaline earth metal compound, is moved in the longitudinal direction of the silica glass tube 20. The melt 30L of the alkaline compound also moves, with the movement of the oxyhydrogen burner 31 for heating the alkaline compound. Moving the oxyhydrogen burner 31 in the longitudinal direction of the silica glass tube 20 as mentioned above makes it easy to move the contact location between the inner circumferential surface of the silica glass tube 20 and the melt 30L of the alkaline compound in the longitudinal direction of the silica glass tube 20.

In one or more embodiments, in the method for manufacturing the optical fiber preform 1P according to the present embodiment, the powder 30P of the alkaline compound is deposited on the inner circumferential surface of the silica glass tube 20 in the alkali doping process P2. The powder 30P of the alkaline compound is deposited on the inner circumferential surface of the silica glass tube 20, thereby making it possible to melt the powder 30P, and thus bring the melt 30L of the alkaline compound and the inner circumferential surface of the silica glass tube 20 into contact with each other. Therefore, a desired location of the inner circumferential surface of the silica glass tube 20 can be doped with alkaline compound by adjusting the location where the powder 30P of the alkaline compound is deposited.

In one or more embodiments, in the method for manufacturing the optical fiber preform 1P according to the present embodiment, the carrier gas CG is flowed on the inner circumferential surface of the silica glass tube 20 from one end of the silica glass tube 20 toward the other thereof in the alkali doping process P2. Flowing the carrier gas CG on the inner circumferential surface of the silica glass tube 20 as just described can limit the direction of moving the melt 30L of the alkaline compound and the powder 30P to the direction of flowing the carrier gas CG, and the alkaline compound can be thus effectively utilized.

In one or more embodiments, in the method for manufacturing the optical fiber preform 1P according to the present embodiment, the carrier gas CG contains oxygen. Flowing oxygen on the inner circumferential surface of the silica glass tube 20 in the alkali doping process P2 can cause the alkaline compound with which the silica glass tube 20 is doped to develop a thermal oxidation reaction. In addition, flowing oxygen as just described can suppress the generation of oxygen-deficient defects as described below on the inner circumferential surface of the silica glass tube 20. In the case of using potassium chloride as an alkaline compound, in the diffusion of the potassium chloride into the silica glass tube, Si—O—Si bonds are cleaved to form Si—O—K bonds and Si—Cl bonds by addition reaction. When moisture of the carrier gas CG flowed on the inner circumferential surface of the silica glass tube 20 and a slight amount of hydroxyl group (Si—O—H) contained in the silica glass tube 20 undergo reactions, Cl is discharged as hydrochloric acid HCl to the outside of the system. Therefore, defects due to oxygen deficiency may be generated on the inner circumferential surface of the silica glass tube 20. In addition, when the silica is heated to a very high temperature, the silica partially volatilizes, and even if the silica is desorbed as SiOx (x>2), oxygen-deficient defects may be generated.

In one or more embodiments, the method for doping the silica glass according to the present embodiment includes the glass tube preparing process P1 and an alkali doping process P2. The method for doping the silica glass according to the present embodiment can, through the alkali doping process P2, reduce the concentration deviation of the alkali metal compound or the alkaline earth metal compound for doping in the longitudinal direction of the silica glass tube 20 while suppressing the crystallization of the silica glass tube 20 as mentioned above.

In addition, the method for manufacturing the optical fiber according to one or more embodiments includes a process of preparing the optical fiber preform 1P by the method for manufacturing the optical fiber preform 1P, and the drawing process P6 of drawing the optical fiber preform 1P. As mentioned above, the optical fiber preform 1P including the silica glass rod 40 doped with the alkaline compound and the silica glass layer formed on the outer circumferential surface of the silica glass rod 40 is obtained according to the method for manufacturing the optical fiber preform 1P. The optical fiber 1 which can reduce the transmission loss is obtained by drawing the optical fiber preform 1P.

While the present invention has only been described with reference to the foregoing embodiments by way of example, the present invention is not to be considered limited to the above embodiments. For example, in one or more embodiments mentioned above, a case of including the additional heating process P3 has been described as an example, but the additional heating process P3 is not an essential process.

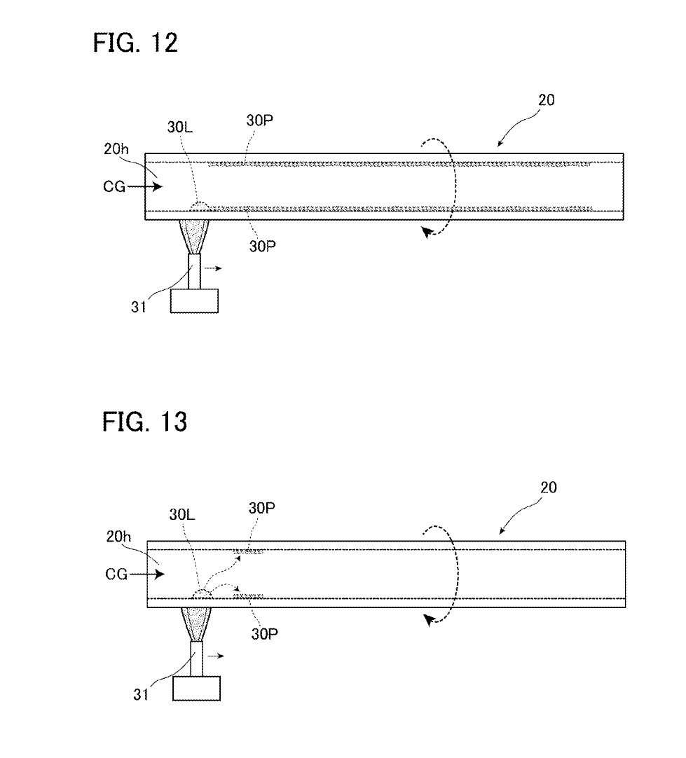

In addition, in one or more embodiments mentioned above, an example of depositing the powder 30P of the alkali metal compound or the alkaline earth metal compound on the inner circumferential surface of the silica glass tube 20 in the alkali doping process P2 has been given and described, but the powder 30P may be deposited on the inner circumferential surface of the silica glass tube 20 prior to the alkali doping process P2. FIG. 12 is a diagram illustrating the state of a scene of the alkali doping process P2 according to a modification example of one or more embodiments of the present invention. In FIG. 12, the same reference numerals are given to the same configurations as those in one or more embodiments mentioned above, and the description thereof will be omitted. As shown in FIG. 12, the inner circumferential surface of the silica glass tube 20 and the melt 30L can be brought into contact with each other by, prior to the alkali doping process P2, depositing the powder 30P on the inner circumferential surface of the silica glass tube 20, and melting the powder 30P with the oxyhydrogen burner 31. In addition, the contact location between the inner circumferential surface of the silica glass tube 20 and the melt 30L can be moved in the same manner as in one or more embodiments mentioned above, by moving the oxyhydrogen burner 31 in the longitudinal direction of the silica glass tube 20 while rotating the silica glass tube 20 around its axis.

In addition, in one or more embodiments mentioned above, a case of forming the recess 20a in the silica glass tube 20 and disposing the compound 30 in the recess 20a has been given and described, but the compound 30 may be disposed on the inner circumferential surface of the silica glass tube 20 without providing the recess 20a in the silica glass tube 20. FIG. 13 is a diagram illustrating the state of a scene of an alkali doping process P2 according to another modification example of one or more embodiments of the present invention. In FIG. 13, the same reference numerals are given to the same configurations as those in one or more embodiments mentioned above, and the description thereof will be omitted. As shown in FIG. 13, even in a case where the compound 30 is disposed on the inner circumferential surface of the silica glass tube 20 without providing the recess 20a in the silica glass tube 20, the inner circumferential surface of the silica glass tube 20 and the melt 30L can be brought into contact with each other by melting the compound 30 on heating with the oxyhydrogen burner 31. In addition, the contact location between the inner circumferential surface of the silica glass tube 20 and the melt 30L can be moved in the same manner as in one or more embodiments mentioned above, by moving the oxyhydrogen burner 31 in the longitudinal direction of the silica glass tube 20 while rotating the silica glass tube 20 around its axis.

In addition, in one or more embodiments mentioned above, a case of using oxygen as the carrier gas CG has been given and described as an example, but as the carrier gas CG, the gases exemplified below can be used, and the gases can be used in mixture. The carrier gas CG may be, for example, an inert gas such as argon, helium, or nitrogen. In addition, the carrier gas CG may be a mixed gas of silicon tetrachloride and oxygen. In this case, since silicon tetrachloride hardly reacts with oxygen at a temperature around the melting point of potassium chloride used as the compound 30 in one or more embodiments mentioned above, silicon dioxide is less likely to be produced. Therefore, the same result is obtained as in the case where an inert gas is used substantially as the carrier gas CG. If silicon dioxide is produced on the inner circumferential surface of the silica glass tube 20, the inner circumferential surface of the silica glass tube 20 undergoes an increase in surface area, and the contact area between the melt 30L and the inner circumferential surface of the silica glass tube 20 can be thus increased. In addition, the carrier gas CG may contain chlorine. The alkaline compound disposed on the inner circumferential surface of the silica glass tube 20 and the impurities contained therein are partially turned into chloride by flowing chlorine on the inner circumferential surface of the silica glass tube 20 in the alkali doping process P2. Most of chlorides of representative metals and transition metals, which are assumed as impurities, are heated at a temperature around the melting point of the alkali metal chloride, thereby also preferentially volatilizing rather than the alkali metal chloride. Therefore, in the alkali doping process P2, the purification of the alkaline compound can be promoted by flowing chlorine on the inner circumferential surface of the silica glass tube 20 and heating the alkaline compound.

In addition, the carrier gas CG is not indispensable. When the carrier gas CG is not used, the powder 30P spreads to both ends of the silica glass tube 20, thereby facilitating the deposition. However, inclining the silica glass tube 20, can also control the direction of movement of the powder 30P and the melt 30L to some extent.

In addition, in one or more embodiments mentioned above, potassium chloride is exemplified as the compound 30, but the compound 30 is not limited thereto. As the compound 30, for example, halides (chlorides, bromides, fluorides, iodides), sulfides, carbonates, hydrogen carbonates, and the like of alkali metals such as lithium, sodium, potassium, rubidium, and cesium, and alkaline earth metals such as beryllium, magnesium, calcium, strontium, and barium can be used. A compound preferred as the compound 30 is appropriately selected depending on substance-specific physical properties such as the melting points of the foregoing compounds, the vapor pressures at each temperature, the thermal capacities of the vapors, and the like. Two or more of the foregoing compounds may be used in mixture. In particular, the halides are preferred, because the halides exhibit melting points without decomposition. In addition, the hydrogen carbonates are preferred, because the hydrogen carbonates are decomposed at low temperatures to turn into carbonates, which have melting points. It is to be noted that it is also possible to use hydroxides, hydrides, salts of organic acids, and the like, but these compounds contain, in the molecules, hydrogen which causes the generation of OH groups, and thus, in the case of using these compounds, it is preferable to apply an additional dehydration treatment.

In addition, in one or more embodiments mentioned above, an example of forming the silica glass layer by a soot method on the outer circumferential surface of the silica glass rod 40 has been given and described, but the method for forming the silica glass layer is not limited thereto. For example, the silica glass layer can also be formed by a jacket method. More specifically, a silica glass layer containing fluorine can be also formed on the outer circumferential surface of the silica glass rod 40 by covering the silica glass rod 40 with a silica glass tube doped with fluorine, and performing the fusion splicing of the inner circumferential surface of the silica glass tube and the outer circumferential surface of the silica glass rod 40.

In addition, in one or more embodiments mentioned above, an example of the clad 12 doped with fluorine has been given and described, but there is no need to dope the clad 12 with fluorine. In a case where the core 11 is doped with a dopant such as germanium for an increase in refractive index, the clad 12 may be pure silica glass doped with no dopant at all. In addition, in order to lower the refractive index of the clad 12, the clad 12 may be doped with boron or the like.

In addition, in one or more embodiments mentioned above, a case where of using the oxyhydrogen burner 31 as a heating means has been described by way of example, but the heating means may be an electric furnace, plasma furnace, or the like.

As described above, according to one or more embodiments of the present invention, provided are: a method for doping silica glass, which can reduce the concentration deviation of the alkali metal compound or the alkaline earth metal compound for doping in the longitudinal direction of the silica glass tube while suppressing the crystallization of the silica glass tube; a method for manufacturing an optical fiber preform with the use of the doping method; and a method for manufacturing an optical fiber with the use of the optical fiber preform. These methods can be utilized in the field of optical fiber communications. In addition, the method can also be utilized for the manufacture of optical fibers for use in fiber laser devices and other devices that use optical fibers.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims

What is claimed is:

1. A method for manufacturing an optical fiber preform, the method comprising:
doping a silica glass tube with an alkali metal compound or an alkaline earth metal compound via an alkali doping process;
collapsing the silica glass tube to form a silica glass rod; and
forming a silica glass layer on an outer circumferential surface of the silica glass rod, wherein
the alkali doping process comprises contacting a part of an inner circumferential surface of the silica glass tube with a melt of the alkali metal compound or the alkaline earth metal compound;
and
during the alkali doping process, a contact location between the inner circumferential surface of the silica glass tube and the melt is moved along a longitudinal direction of the silica glass tube while rotating the silica glass tube around its longitudinal axis.

2. The method according to claim 1, wherein the alkali doping process further comprises heating the alkali metal compound or the alkaline earth metal compound by moving a heat source along the longitudinal direction of the silica glass tube.

3. The method according to claim 1, wherein prior to the alkali doping process, a powder of the alkali metal compound or the alkaline earth metal compound is deposited on the inner circumferential surface of the silica glass tube.

4. The method according to claim 1, wherein after the alkali doping process, the silica glass tube is further heated.

5. The method according to claim 1,
wherein the alkali doping process further comprises flowing a gas on the inner circumferential surface of the silica glass tube from one end of the silica glass tube toward the other thereof.

6. The method according to claim 5, wherein the gas contains oxygen.

7. The method according to claim 5, wherein the gas contains chlorine.

8. The method according to claim 1,
wherein the alkali metal compound comprises a halide of an alkali metal.

9. The method according to claim 8, wherein the alkali metal is potassium.

10. A method for doping silica glass, the method comprising:
preparing a silica glass tube; and
doping the silica glass tube with the alkali metal compound or the alkaline earth metal compound by an alkali doping process,
wherein the alkali doping process comprises bringing a melt of an alkali metal compound or an alkaline earth metal compound into contact with a part of an inner circumferential surface of the silica glass tube, and
during the alkali doping process, a contact location between the inner circumferential surface of the silica glass tube and the melt is moved along a longitudinal direction of the silica glass tube while rotating the silica glass tube around its longitudinal axis.

11. A method for manufacturing an optical fiber, the method comprising:
preparing an optical fiber preform by the method according to claim 1; and
drawing the optical fiber preform.
